(19) United States
(12) Patent Application Publication
(10) Pub. No.: US 2004/0245693 A1
(43) Pub. Date: Dec. 9, 2004

(54) Form a-fixture

(76) Inventor: Gunther Siegel, La Grangeville, NY (US)

Correspondence Address: JOSEPH B. TAPHORN, Esq., 8 SCENIC DRIVE, HAGAN FARMS, POUGHKEEPSIE, NY, 12603, US

(21) Appl. No.: 10/453,265

(22) Filed: Jun. 4, 2003

(51) Int. Cl. B23Q 3/00

(52) U.S. Cl. 269/43

(57) ABSTRACT

A fixture for rapidly and precisely mounting uniquely-shaped work-pieces in machine tools, incorporates a U-shaped member whose bight is fixed to the fixture and whose upright legs constitute levers on the free ends of which are formed lateral outside and inside surfaces. The outside surfaces engage the work-pieces; the inside surfaces, convex in the vertical direction, are engaged by an operator to move the lever free ends outwards to engage the work-pieces. The operator is a vertical cone, driven axially by a bolt fixed to it and threaded into the fixture through the bight. The U-shaped member may be seated in a well on the fixture, and cut-outs on the surfaces of the fixture and the lever free ends have edges complementary to the work pieces and receive the work-pieces prior to being fixed on the fixture. In an alternative embodiment, the outside surfaces of the lever free ends my engage the inside of a work-piece to fix it on the fixture.

### 1. FIELD OF THE INVENTION

This invention relates to machine tools; more particularly, to fixtures for rapidly and accurately mounting work-pieces for reduction or finishing as by turning, shaping, planing, or milling, in machine tools.

### 2. BACKGROUND OF THE INVENTION

Machine tools (machines for doing work with cutting tools) may mount work-pieces via fixtures. A fixture is an object of a standard dimension adapted to be readily placed and secured in a machine tool, and formed to hold a work-piece placed on it off-line, in a precise position on it. Hence when the fixture is properly placed in a machine tool, it precisely positions the work-piece for cutting action.

Uniquely-shaped work-pieces require special consideration.

The position of a uniquely-shaped work-piece on the fixture may be determined by the structure and contour formed in the fixture. Thus the fixture may be formed with a surface complementary to surface of the uniquely-shaped work-piece and against which the latter surface is clamped. Or a precisely positioned clamp on the fixture may itself hold the work-piece for machining operations.

It will be evident that rapid mounting and de-mounting of a uniquely-shaped work-piece on the fixture is desirable.

It will be further evident that quick and accurate placement of two or more uniquely-shaped work-pieces on a fixture at the same time is beneficial too.

### 3. PRIOR ART

Loading fixtures off-line is old. Locking a loaded work-piece on the fixture, as by a wedging action, is old too.

### SUMMARY OF THE INVENTION

Accordingly, it is an object of this invention to facilitate the rapid placement of a uniquely-shaped work-piece on a fixture.

Another object of the invention is to enable the rapid placement a uniquely-shaped work-piece accurately in a fixture.

A related object of the invention is to enable the rapid removal a uniquely-shaped work-piece from a fixture

Yet another object of the invention is to enable quickly mounting accurately two uniquely-shaped work-pieces on a fixture at a time.

Another related object of the invention is to enable the quick dismounting of two uniquely-shaped work-pieces from a fixture.

A further object of the invention is to provide a fixture for uniquely-shaped work-pieces that is reliable of operation and easy of use.

Still another object of the invention is to provide a fixture for uniquely-shaped work-pieces that is simple and inexpensive of construction and easy of manufacture.

A yet further object of the invention is to provide a fixture for uniquely-shaped work-pieces that will also readily handle standard-shaped workpieces.

The objects of the invention are achieved by providing a new arrangement for clamping a uniquely-shaped work-piece precisely onto a fixture. The arrangement involves an angularly-yieldable positioning element having a rim surface for engaging the complementary edge of a uniquely-shaped work-piece. In a first embodiment, the fixture is formed with a rim surface for seating another edge of the uniquely-shaped work-piece. Advantageously, a second angularly-yieldable positioning element having a rim surface for engaging the complementary edge of a uniquely-shaped work-piece may be employed, the fixture being formed with a second rim surface for seating another edge of the uniquely-shaped work-piece, and the angularly-yieldable positioning elements being moved by a common operator.

In a second embodiment, the arrangement involves a first angularly-yieldable positioning element having a rim surface for engaging the complementary edge of a uniquely-shaped work-piece, and a second angularly-yieldable positioning element having a rim surface for engaging a complementary edge of the uniquely-shaped work-piece.

In the first embodiment, a lever fixed at one end to the fixture has its free end formed with a first surface which can be moved against a surface of a work-piece and with a second surface which can be engaged by a cam displaceable transversely with respect to the lever. Preferably the lever second surface is convex in the cam traverse direction so that only a point of contact obtains between it and the cam whose surface is the frustum of a right circular cone. Axial traverse or displacement of the cam is effected by centrally mounting the cone on the upper end of a bolt threadedly received at its lower end in the fixture and/or the fixed end of the lever. The conical cam makes point contact with the lever convex second surface allowing the free end to yield about the point contact and conform to the surface of the workpiece.

Advantageously the lever is combined with a second lever, disposed in mirror image to it, and joined to form a U-shaped structure which is anchored at its bight to the fixture. An opening in the bight may allow the cone bolt to pass through and be threadedly received in the fixture, and so that the cone cam surface may reside operatively between the two levers. Thus the cone forces the two levers apart when the bolt is turned down, to urge the work-piece engaging first surfaces of the levers outward into engagement with the work-piece or work-pieces to lock a work-piece or work-pieces in precisely-determined locations in the fixture.

If the fixture is provided with a well on its surface, the U-shaped lever structure may have its bight anchored to the bottom of the well and the free ends of its levers disposed to press work-pieces oppositely disposed about the well so that surfaces thereon engage complementary surfaces formed by cuts in the adjacent areas of the fixture.

If the U-shaped lever structure is mounted on the surface of the fixture, the opposing levers might be made to engage complementary inside surfaces on a work-piece. The complementary surfaces on the levers would be on the outside.

Another feature of the invention is that the conical surface of the cone and the engaged convex surfaces of the levers having a line or point of contact between them, enable the movement of and the pressure applied to the levers per partial turn of the cone bolt, to be made to vary as mounting and de-mounting of the work-piece proceeds. The flatter upper areas of the convex surfaces of the levers will result is less lever movement during initial downward displacement of the cone. And the steepness of the cone and lever surfaces may be selected to provide the desired lateral forces per partial turn of the cone bolt.

A further feature of the invention is that the pressure to hold the work-pieces in place may be made to rise rapidly with turning of the cone bolt. Thus as the cone moves downward, the cone engages the levers more remotely from the work-pieces which are at their free ends, and the resultant increased leverage moves the levers more forcibly against the work-pieces to lock them in place.

Yet another feature of the invention is that should one of the work-pieces be of slightly different dimension, the cone surface may shift slightly via flexing of the bolt to still apply essentially-equal holding pressure on the work-pieces.

### BRIEF DESCRIPTION OF INVENTION PREFERRED EMBODIMENTS

These and other objects, features and advantages of the invention will become apparent from a reading of the following description when considered with the appended drawings of preferred embodiments of the invention, wherein:

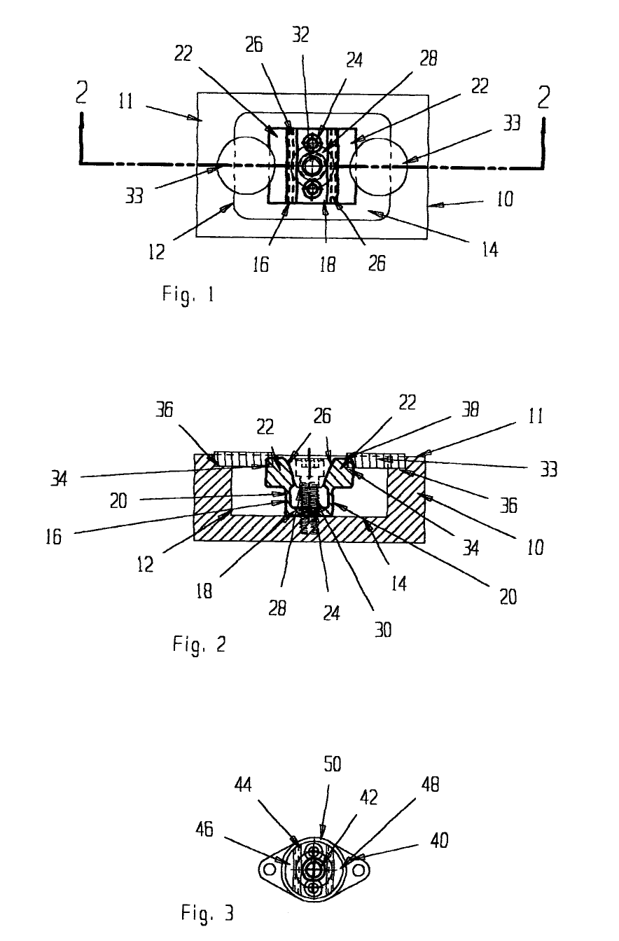

FIG. 1 is a top view of a welled fixture clamping down two work-pieces;

FIG. 2 is a partial sectional view taken along the lines 2-2 of FIG. 1; and

FIG. 3 is a top view of a non-welled fixture clamping down a ringed work-piece.

### DETAILED DESCRIPTION OF PREFERRED INVENTION EMBODIMENTS

Referring now particularly to the drawings, there is shown in FIGS. 1 and 2 a machine-tool standard fixture 10 in the form of a block having in its upper surface 11 a well 12. The well 12 mounts on its bottom 14 a U-shaped lever structure generally indicated by the numeral 16.

The U-shaped lever structure 16 is formed with a flat bight 18 upwardly from the ends of which extend two levers 20. The upper ends of the levers 20 terminate in blocks 22. As best seen in FIG. 1, the blocks 22 extend sideways across most of the width of the fixture well 12. It will be appreciated that the blocks 22 are the upper and free ends of the levers 20 integral with the bight 18 to form the U-shaped lever structure 16. The U-shaped lever structure 16 is secured to the floor 14 of the fixture well 12 by bolts 24 (FIG. 1) extending through the bight 18.

The lever blocks 22 on their inside or opposing surfaces 26 are convex in an upwardly and outwardly direction. An appropriately dimensioned conical cam generally indicated by the numeral 28 is operatively disposed between the lever blocks 22.

The conical cam 28 is the frustum of a right circular cone whose conical surface engages the convex surfaces of the lever blocks 22. The geometry of the surfaces is such that they engage each other in a point of contact.

The conical cam 28 is centrally mounted upon and fixed to a bolt 30 extending there through. Conveniently, the upper end of the bolt is recessed as at 32 to receive an allyn wrench for turning the bolt 30 to move the conical cam 28 up and down. As the conical cam 28 moves down, it pushes the lever blocks 22 outward from a normal position.

As the lever blocks 22 move outward, they engage work-pieces such as discs 33. The work-pieces 33 may be seated in cut-outs 34 and 36 formed opposite each other in adjacent upper surfaces 38 and 11 of the lever blocks 22 and the fixture 10 respectively. The shapes of the cut-outs 34 and 36 may be complementary to that of the work-pieces 33 to enable exact careful engagement and precise location of them for cutting action in the machine tool. The work-pieces 33 will be firmly held in the proper positions by the action of the conical cam 28 displacing the lever blocks 22 outward to where they forcefully engage the work-pieces in their cut-outs 34 and move them in their fixture cut-outs 36 to where they are frictionally held in place at precise locations.

In use, a fixture 10 would normally be loaded off-line. To this end, the discs 33 would be placed in the cut-outs 34 and 36, the conical cam 28 being backed-off as with an allyn wrench if the discs 33 did not fit within the cut-outs. Thereafter, the conical cam 28 would be turned downward until the lever blocks 22 firmly seated the discs 33 in the fixture. Thereafter, the fixture would be placed in the machine tool for cutting operations on the discs 33 while another fixture was being fitted with more discs 33. Applicant's invention enables a 100% speed up in operation.

In another embodiment (FIG. 3), a fixture 40 of another shape and without a well, is employed. The fixture is shown as mounting an appropriately dimensioned conical cam generally indicated by the numeral 42 operatively in a U-shaped lever structure generally indicated by the numeral 44. The U-shaped lever structure 44 has lever blocks 46 and 48. The out-side edges of the lever blocks 46 and 48 are rounded and so as to be complementary to the inside surface of a work-piece ring 50 placed thereabout. Downward displacement of the conical cam 42 moves the lever blocks 46 and 48 outward to where they firmly engage and hold the work-piece ring 50. The fixture can then be placed in a machine tool for cutting operations on the ring 50 while another is being loaded on another fixture offline.

While there has been shown and described preferred embodiments of the invention, it will be apparent to those skilled in the art that other and different applications may be made of the principles of the invention. It is intended therefore to be limited only by the scope or spirit of the appended claims.

What is claimed is:

1. A fixture for rapidly loading and unloading work-pieces for machining in a machine tool comprising a block, a cut-away shape in the block for receiving a complementarily-shaped work-piece, a lever anchored on said block, and a displaceable element for moving the lever to engage a received work-piece and hold it firmly in place.

2. A fixture according to claim 1, wherein the lever presents a convex surface to the displaceable element.

3. A fixture according to claim 2, wherein the displaceable element engages the lever via a translating surface.

4. A fixture according to claim 3, wherein the displaceable-element having a translating surface is the frustum of a cone.

5. A fixture according to claim 4, wherein the frustum of a cone is mounted on a bolt threadedly received in the block.

6. A fixture according to claim 5, wherein there is a second cut-away shape in the block for receiving another complementarily-shaped work-piece, and a second lever anchored on said block to abut a received work-piece in the second cut-away shape and presenting a convex surface to the displaceable element.

7. A fixture according to claim 6, wherein the first and the second lever are integrated into a common structure.

8. A fixture according to claim 7, wherein the first and second levers are the arms of a U-shaped structure secured by its bight to the block.

9. A fixture according to claim 8, wherein the a well is formed in the surface of the block, and the U-shaped structure is secured in the bottom of it.

10. A fixture according to claim 2, wherein the lever convex surface is convex in the vertical direction, and the displaceable element is a vertical moving cone whose translating surface engages the lever convex surface.

11. An arrangement for clamping a uniquely-shaped work-piece precisely onto a machine-tool fixture comprising an angularly-yieldable positioning element, a rim surface on the positioning element for engaging the complementary edge of a uniquely-shaped work-piece, and an operator for making point contact with angularly-yieldable positioning element.

12. An arrangement according to claim 11, wherein the angularly-yieldable positioning element is the free end of a lever.

13. An arrangement according to claim 11, wherein rim surface on the positioning element for engaging the complementary edge of a uniquely-shaped work-piece is formed by a cut-out on the element.

14. An arrangement according to claim 11, wherein there is a convex surface on the angularly-yieldable positioning element, and the operator for making point contact with angularly-yieldable positioning element includes a cone for doing so.

15. An arrangement according to claim 11, wherein the arrangement a second angularly-yieldable positioning element, a rim surface on the second positioning element for engaging the complementary edge of a uniquely-shaped work-piece, and a common operator for making point contact with both angularly-yieldable positioning elements.

16. An arrangement according to claim 15, wherein the angularly-yieldable positioning elements are the free ends of levers.

17. An arrangement according to claim 15, wherein rim surfaces on the positioning elements for engaging the complementary edges of a uniquely-shaped work-piece are formed by cut-outs on the elements.

18. An arrangement according to claim 15, wherein there are convex surfaces on the angularly-yieldable positioning elements, and the common operator for making point contact with angularly-yieldable positioning elements includes a cone for doing so.

19. For use in a fixture for rapidly loading and unloading work-pieces for machining in a machine tool, a U-shaped lever structure comprising a flat bight, levers extending upwardly from the bite, and elements on the upper ends of the levers for engaging work-pieces.

20. A U-shaped lever structure according to claim 19, wherein the outside of the elements are formed with surfaces for engaging the complementary surfaces of work-pieces and the inside of the elements are formed with surfaces for engagement by an operator.
